(19) United States
(12) Patent Application Publication
(10) Pub. No.: US 2006/0259251 A1
(43) Pub. Date: Nov. 16, 2006

(54) Computer software products for associating gene expression with genetic variations

(75) Inventor: Janet A. Warrington, Los Altos, CA (US)

Correspondence Address: AFFYMETRIX, INC;ATTN: CHIEF IP COUNSEL, LEGAL DEPT., 3420 CENTRAL EXPRESSWAY, SANTA CLARA, CA, 95051, US

(73) Assignee: Affymetrix, INC., Santa Clara, CA (US)

(21) Appl. No.: 11/443,794

(22) Filed: May 30, 2006

Related U.S. Application Data
(63) Continuation of application No. 09/955,357, filed on Sep. 10, 2001.
(60) Provisional application No. 60/231,365, filed on Sep. 8, 2000.

(51) Int. Cl. G06F 19/00

(52) U.S. Cl. 702/20

(57) ABSTRACT

The presently claimed invention provides methods for identifying single nucleotide polymorphisms (SNPs) whose state segregatea with gene expression data. In an exemplary embodiment, samples from individuals are hybridized with arrays that are capable of detecting SNP states and gene expression. Methods, computer software products and systems are provided to identify the genes whose expression is affected by the states of SNPs.

### RELATED APPLICATIONS

This application is related to and claims the priority of U.S. Provisional Application Ser. No. 60/231,365, filed on Sep. 8, 2000. The 60/231,365 application is incorporated herein by reference in its entity for all purposes.

### FIELD OF INVENTION

This invention is related to bioinformatics and biological data analysis. Specifically, this invention provides methods, computer software products and systems for analyzing genotyping and gene expression data. Specifically, some embodiments of this invention provides methods, computer software products and systems for comparing nucleotide variant data with gene expression data to obtain a correlation between phenotype and genotype.

### BACKGROUND OF THE INVENTION

Single nucleotide polymorphism (SNP) has been used extensively for genetic analysis. Fast and reliable hybridization-based SNP assays have been developed. (See Wang, et al., Large-Scale Identification, Mapping, and Genotyping of Single-Nucleotide Polymorphism's in the Human Genome, Science 280:1077-1082, 1998; Gingeras, et al., Simultaneous Genotyping and Species Identification Using Hybridization Pattern Recognition Analysis of Generic Mycobacterium DNA Arrays, Genome Research 8:435-448, 1998; Halushka, et al., Patterns of Single-Nucleotide Polymorphisms in Candidate Genes for Blood-Pressure Homeostasis, Nature Genetics 22:239-247, 1999; Cutler, et al., High throughput variation detection and genotyping using microarrays. Genome Research (in press), 2001, all incorporated herein by reference in their entireties.

Computer-implemented methods for discovering polymorphism and determining genotypes are disclosed in, e.g., U.S. Pat. No. 5,858,659, incorporated herein by reference in its entirety for all purposes. Methods, computer software and systems for determining genotypes using pattern recognition are also disclosed in U.S. patent application Ser. No. 09/758,872, which is incorporated herein by reference in its entity for all purposes.

While many SNPs have no functional significance, certain SNPs may be functional, for example, by affecting the expression of genes. Discovering the functions of such SNPs is important for drug development, diagnostics and pharmacogenomics. Therefore, there is a great need in the art for methods for associating biological functions with SNPs.

### SUMMARY OF THE INVENTION

In one preferred embodiments, methods are provided for identifying single nucleotide polymorphisms (SNPs) whose state, i.e. wild type (WT), heterozygous (Het), or homozygous (Hom), segregate with gene expression data such that a particular SNP state will correlate with a particular level of gene expression. In one embodiment, the nucleotide variation information and expression information is obtained by hybridization of nucleic acid samples to high density nucleic acid arrays. Samples from the same individual are hybridized to arrays which are designed to interrogate for nucleotide variation and gene expression information. In some cases, this may involve samples being hybridized to two or more different arrays.

In one aspect of the invention, methods are provided for correlating gene expression with genetic variations. The preferred methods involve obtaining a first plurality of gene expression profiles from a plurality of individuals with a first genotype; obtaining a second plurality of gene expression profiles from a plurality of individuals with a second genotype; comparing the first and second gene expression profiles; and indicating the genes whose expression segregates with the genotypes as the genes affected by the genotypes. The genotypes may be the states of a SNP or haplotypes, etc. Typically, the gene expression profiles have at least 2, 5, 10, 100, 500, 1,000, 5,000, 10,000, 50,000 genes.

The step of comparing may include a step of evaluating the difference in gene expression between the first and second genotypes. In preferred embodiments, the step of evaluating including calculating a normalized difference in gene expression between the first and second genotypes. In a particularly preferred embodiment, the step of comparing includes a step of calculating a SNPmetric for each SNP and each gene according to:

$${}_{}^{gene}{Γ}{}_{SNP}^{} = \frac{{( {E}_{wt}^{avg} - {E}_{e / o}^{avg} )}^{c}}{{σ}_{wt}^{a} {σ}_{e / o}^{b}}$$

$$or$$

$${}_{}^{gene}{Γ}{}_{SNP}^{} = \frac{{\vert ( {E}_{wt}^{avg} - {E}_{e / o}^{avg} ) \vert}^{c}}{{σ}_{wt}^{a} {σ}_{e / o}^{b}}$$

where:
   ^{gene}Γ_{SNP}=SNPmetric for a given gene;
   E_{wt}^{avg}=average gene expression for wild type SNP for the gene;
   E_{e/o}^{avg}=average gene expression for heterozygous/homozygous mutant for the gene;
   σ_{wt}=standard deviation of gene expression of wild type SNP for the gene;
   σ_{e/o}=standard deviation of gene expression of heterozygous/homozygous mutant for the gene; and
   a, b, c=sensitivity parameters. In some instances, b=0.

In a particularly preferred embodiments, a large number of genotypes, even all genotypes, are compared to all expression profiles simultaneously.

In another aspect of the invention, computer software products for correlating gene expression with genetic variations are provided. The software products may include computer program code that inputs a first plurality of gene expression profiles from a plurality of individuals with a first genotype; computer program code that inputs a second plurality of gene expression profiles from a plurality of individuals with a second genotype; computer program code that compares the first and second gene expression profiles; computer program code that indicates the genes whose expression segregates with the genotypes as the genes affected by the genotypes; and a computer readable medium for storing the codes. The genotypes may be the states of a SNP or haplotypes. In preferred embodiments, the gene expression profiles have at least 500, 1,000, 5,000, 10,000 or 50,000 genes. The code that compares may include code that evaluates the difference in gene expression between the first and second genotypes. More preferrably, the code that evaluates includes code that calculates a normalized difference in gene expression between the first and second genotypes. In a particularly preferred embodiment, the software products include code that calculates a SNPmetric for each SNP and each gene according to

$${}_{}^{gene}{Γ}{}_{SNP}^{} = \frac{{( {E}_{wt}^{avg} - {E}_{e / o}^{avg} )}^{c}}{{σ}_{wt}^{a} {σ}_{e / o}^{b}}$$

$$or$$

$${}_{}^{gene}{Γ}{}_{SNP}^{} = \frac{{\vert ( {E}_{wt}^{avg} - {E}_{e / o}^{avg} ) \vert}^{c}}{{σ}_{wt}^{a} {σ}_{e / o}^{b}}$$

where:
   ^{gene}Γ_{SNP}=SNPmetric for a given gene;
   E_{wt}^{avg}=average gene expression for wild type SNP for the gene;
   E_{e/o}^{avg}=average gene expression for heterozygous/homozygous mutant for the gene;
   σ_{wt}=standard deviation of gene expression of wild type SNP for the gene;
   σ_{e/o}=standard deviation of gene expression of heterozygous/homozygous mutant for the gene; and
   a, b, c=sensitivity parameters.

In yet another aspect of the invention, system and computer readable media for performing some steps of the invention are provided. The systems include a processor; and a memory coupled with the processor, the memory storing a plurality of machine instructions that cause the processor to perform logical steps of the methods of the invention. The computer readable media of the invention contains computer-executable instructions for performing some method steps of the invention.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates an example of a computer system that may be utilized to execute the software of an embodiment of the invention.

FIG. 2 is a system block diagram of the computer system of FIG. 1.

FIG. 3 shows a computer network suitable for use with some embodiments of the invention.

FIG. 4A shows an image of hybridization of a sample to a SNP discovery probe array (custom SNP discovery array, Affymetrix, Inc., Santa Clara, Calif.).

FIG. 4B shows an image of hybridization of a sample to a gene expression probe array (GeneChipg HuGeneFL probe array, Affymetrix, Inc., Santa Clara, Calif.).

FIG. 5 shows a process for detecting/discovering SNPs in transcripts.

FIG. 6 shows a process for identifying candidate SNPs with biological relevance.

FIG. 7 shows a computerized process for identifying SNPs that are correlated with the distribution of expression.

FIG. 8 shows an embodiment of the computerized process of the invention for calculating a SNPmetric.

### DETAILED DESCRIPTION OF THE PREFERRED EMBODIMENTS

Reference will now be made in detail to the preferred embodiments of the invention. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention. All cited references, including patent and non-patent literature, are incorporated herein by reference in their entireties for all purposes.

In preferred embodiments, methods are provided for identifying single nucleotide polymorphisms (SNPs) whose state, i.e. wild type (WT), heterozygous (Het), or homozygous (Hom), segregate with gene expression data such that a particular SNP state will correlate with a change in gene expression. The method preferably uses nucleotide variation information derived from hybridization assays in combination with expression information derived from hybridization assays to obtain or predict a correlation between a particular genotype and a particular phenotype.

Various aspect of the invention will be described using SNPs and probe arrays in exemplary embodiments. However, the methods, software and systems are not limited to analyzing biological relevance of SNPs using array based detection technology. Rather, this invention may be applied to, for example, determining finctional association between any genotype (such as haplotype) and phenotype. Genotyping and gene expression monitoring can be performed using any suitable technology.

### I. High Density Probe Arrays

In preferred embodiments, the methods, computer software and systems of the invention are used for analyzing genotyping and gene expression data generated using high density probe arrays, such as high density nucleic acid probe arrays.

High density nucleic acid probe arrays, also referred to as “DNA Microarrays,” have become a method of choice for monitoring the expression of a large number of genes and for detecting sequence variations, mutations and polymorphism. As used herein, “nucleic acids” may include any polymer or oligomer of nucleosides or nucleotides (polynucleotides or oligonucleotidies), which include pyrimidine and purine bases, preferably cytosine, thymine, and uracil, and adenine and guanine, respectively. (See Albert L. Lehninger, PRINCIPLES OF BIOCHEMISTRY, at 793-800 (Worth Pub. 1982) and L. Stryer, BIOCHEMISTRY, 4th Ed. (March 1995), both incorporated by reference.) “Nucleic acids” may include any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

“A target molecule” refers to a biological molecule of interest. The biological molecule of interest can be a ligand, receptor, peptide, nucleic acid (oligonucleotide or polynucleotide of RNA or DNA), or any other of the biological molecules listed in U.S. Pat. No. 5,445,934 at col. 5, line 66 to col. 7, line 51, which is incorporated herein by reference for all purposes. For example, if transcripts of genes are the interest of an experiment, the target molecules would be the transcripts. Other examples include protein fragments, small molecules, etc. “Target nucleic acid” refers to a nucleic acid (often derived from a biological sample) of interest. Frequently, a target molecule is detected using one or more probes. As used herein, a “probe” is a molecule for detecting a target molecule. It can be any of the molecules in the same classes as the target referred to above. A probe may refer to a nucleic acid, such as an oligonucleotide, capable of binding to a target nucleic acid of complementary sequence through one or more types of chemical bonds, usually through complementary base pairing, usually through hydrogen bond formation. As used herein, a probe may include natural (i.e., A, G, U, C, or T) or modified bases (7-deazaguanosine, inosine, etc.). In addition, the bases in probes may be joined by a linkage other than a phosphodiester bond, so long as the bond does not interfere with hybridization. Thus, probes may be peptide nucleic acids in which the constituent bases are joined by peptide bonds rather than phosphodiester linkages. Other examples of probes include antibodies used to detect peptides or other molecules, any ligands for detecting its binding partners. When referring to targets or probes as nucleic acids, it should be understood that these are illustrative embodiments that are not to limit the invention in any way.

In preferred embodiments, probes may be immobilized on substrates to create an array. An “array” may comprise a solid support with peptide or nucleic acid or other molecular probes attached to the support. Arrays typically comprise a plurality of different nucleic acids or peptide probes that are coupled to a surface of a substrate in different, known locations. These arrays, also described as “microarrays” or colloquially “chips” have been generally described in the art, for example, in Fodor et al., Science, 251:767-777 (1991), which is incorporated by reference for all purposes. Methods of forming high density arrays of oligonucleotides, peptides and other polymer sequences with a minimal number of synthetic steps are disclosed in, for example, U.S. Pat. Nos. 5,143,854, 5,252,743, 5,384,261, 5,405,783, 5,424,186, 5,429,807, 5,445,943, 5,510,270, 5,677,195, 5,571,639, 6,040,138, all incorporated herein by reference for all purposes. The oligonucleotide analogue array can be synthesized on a solid substrate by a variety of methods, including, but not limited to, light-directed chemical coupling, and mechanically directed coupling. (See Pirrung et al., U.S. Pat. No. 5,143,854, PCT Application No. WO 90/15070) and Fodor et al., PCT Publication Nos. WO 92/10092 and WO 93/09668, U.S. Pat. Nos. 5,677,195, 5,800,992 and 6,156,501, which disclose methods of forming vast arrays of peptides, oligonucleotides and other molecules using, for example, light-directed synthesis techniques.) (See also Fodor, et al., Science, 251, 767-77 (1991)). These procedures for synthesis of polymer arrays are now referred to as VLSIPS™ procedures.

Methods for making and using molecular probe arrays, particularly nucleic acid probe arrays are also disclosed in, for example, U.S. Pat. Nos. 5,143,854, 5,242,974, 5,252,743, 5,324,633, 5,384,261, 5,405,783, 5,409,810, 5,412,087, 5,424,186, 5,429,807, 5,445,934, 5,451,683, 5,482,867, 5,489,678, 5,491,074, 5,510,270, 5,527,681, 5,527,681, 5,541,061, 5,550,215, 5,554,501, 5,556,752, 5,556,961, 5,571,639, 5,583,211, 5,593,839, 5,599,695, 5,607,832, 5,624,711, 5,677,195, 5,744,101, 5,744,305, 5,753,788, 5,770,456, 5,770,722, 5,831,070, 5,856,101, 5,885,837, 5,889,165, 5,919,523, 5,922,591, 5,925,517, 5,658,734, 6,022,963, 6,150,147, 6,147,205, 6,153,743 and 6,140,044, all of which are incorporated by reference in their entireties for all purposes.

Microarray can be used in a variety of ways. A preferred microarray contains nucleic acids and is used to analyze nucleic acid samples. Typically, a nucleic acid sample is prepared from appropriate source and labeled with a signal moiety, such as a fluorescent label. The sample is hybridized with the array under appropriate conditions. The arrays are washed or otherwise processed to remove non-hybridized sample nucleic acids. The hybridization is then evaluated by detecting the distribution of the label on the chip. The distribution of label may be detected by scanning the arrays to determine fluorescence intensity distribution. Typically, the hybridization of each probe is reflected by several pixel intensities. The raw intensity data may be stored in a gray scale pixel intensity file. The GATC™ Consortium has specified several file formats for storing array intensity data. The final software specification is available at www.gatcconsortium.org and is incorporated herein by reference in its entirety. The pixel intensity files are usually large. For example, a GATC™ compatible image file may be approximately 50 Mb if there are about 5000 pixels on each of the horizontal and vertical axes and if a two byte integer is used for every pixel intensity. The pixels may be grouped into cells. (See GATC™ software specification). The probes in a cell are designed to have the same sequence; i.e., each cell is a probe area. A CEL file contains the statistics of a cell, e.g., the 75th percentile and standard deviation of intensities of pixels in a cell. The 50, 60, 70, 75 or 80th percentile of pixel intensity of a cell is often used as the intensity of the cell.

The Affymetrix® Analysis Data Model (AADM) is the relational database schema Affymetrix uses to store experiment results. It includes tables to support mapping, spotted arrays and expression results. Affymetrix publishes AADM to support open access to experiment information generated and managed by Affymetrix® software so that results may be filtered and mined with any compatible analysis tools. The AADM specification (Affymetrix, Santa Clara, Calif., 2001) is incorporated herein by reference for all purposes. The specification is available at http://www.affymetrix.com/support/aadm/aadm.html, last visited on Sep. 4, 2001.

Methods for signal detection and processing of intensity data are additionally disclosed in, for example, U.S. Pat. Nos. 5,445,934, 547,839, 5,578,832, 5,631,734, 5,800,992, 5,856,092, 5,936,324, 5,981,956, 6,025,601, 6,090,555, 6,141,096, 6,141,096, and 5,902,723. Methods for array based assays, computer software for data analysis and applications are additionally disclosed in, e.g., U.S. Pat. Nos. 5,527,670, 5,527,676, 5,545,531, 5,622,829, 5,631,128, 5,639,423, 5,646,039, 5,650,268, 5,654,155, 5,674,742, 5,710,000, 5,733,729, 5,795,716, 5,814,450, 5,821,328, 5,824,477, 5,834,252, 5,834,758, 5,837,832, 5,843,655, 5,856,086, 5,856,104, 5,856,174, 5,858,659, 5,861,242, 5,869,244, 5,871,928, 5,874,219, 5,902,723, 5,925,525, 5,928,905, 5,935,793, 5,945,334, 5,959,098, 5,968,730, 5,968,740, 5,974,164, 5,981,174, 5,981,185, 5,985,651, 6,013,440, 6,013,449, 6,020,135, 6,027,880, 6,027,894, 6,033,850, 6,033,860, 6,037,124, 6,040,138, 6,040,193, 6,043,080, 6,045,996, 6,050,719, 6,066,454, 6,083,697, 6,114,116, 6,114,122, 6,121,048, 6,124,102, 6,130,046, 6,132,580, 6,132,996 and 6,136,269, all of which are incorporated by reference in their entireties for all purposes.

Nucleic acid probe array technology, use of such arrays, analysis array based experiments, associated computer software, composition for making the array and practical applications of the nucleic acid arrays are also disclosed, for example, in the following U.S. patent application Ser. Nos.: 07/838,607, 07/883,327, 07/978,940, 08/030,138, 08/082,937, 08/143,312, 08/327,522, 08/376,963, 08/440,742, 08/533,582, 08/643,822, 08/772,376, 09/013,596, 09/016,564, 09/019,882, 09/020,743, 09/030,028, 09/045,547, 09/060,922, 09/063,311, 09/076,575, 09/079,324, 09/086,285, 09/093,947, 09/097,675, 09/102,167, 09/102,986, 09/122,167, 09/122,169, 09/122,216, 09/122,304, 09/122,434, 09/126,645, 09/127,115, 09/132,368, 09/134,758, 09/138,958, 09/146,969, 09/148,210, 09/148,813, 09/170,847, 09/172,190, 09/174,364, 09/199,655, 09/203,677, 09/256,301, 09/285,658, 09/294,293, 09/318,775, 09/326,137, 09/326,374, 09/341,302, 09/354,935, 09/358,664, 09/373,984, 09/377,907, 09/383,986, 09/394,230, 09/396,196, 09/418,044, 09/418,946, 09/420,805, 09/428,350, 09/431,964, 09/445,734, 09/464,350, 09/475,209, 09/502,048, 09/510,643, 09/513,300, 09/516,388, 09/528,414, 09/535,142, 09/544,627, 09/620,780, 09/640,962, 09/641,081, 09/670,510, 09/685,011, and 09/693,204 and in the following Patent Cooperative Treaty (PCT) applications/publications: PCT/NL90/0008 1, PCT/GB91/00066, PCT/US91/08693, PCT/US91/09226, PCT/US91/09217, WO/93/10161, PCT/US92/10183, PCT/GB93/00147, PCT/US93/01152, WO/93/22680, PCT/US93/04145, PCT/US93/08015, PCT/US94/07106, PCT/US94/12305, PCT/GB95/00542, PCT/US95/07377, PCT/US95/02024, PCT/US96/05480, PCT/US96/11147, PCT/US96/14839, PCT/US96/15606, PCT/US97/01603, PCT/US97/02102, PCT/GB97/005566, PCT/US97/06535, PCT/GB97/01148, PCT/GB97/01258, PCT/US97/08319, PCT/US97/08446, PCT/US97/10365, PCT/US97/17002, PCT/US97/16738, PCT/US97/19665, PCT/US97/20313, PCT/US97/21209, PCT/US97/21782, PCT/US97/23360, PCT/US98/06414, PCT/US98/01206, PCT/GB98/00975, PCT/US98/04280, PCT/US98/04571, PCT/US98/05438, PCT/US98/05451, PCT/US98/12442, PCT/US98/12779, PCT/US98/12930, PCT/US98/13949, PCT/US98/15151, PCT/US98/15469, PCT/US98/15458, PCT/US98/15456, PCT/US98/16971, PCT/US98/16686, PCT/US99/19069, PCT/US98/18873, PCT/US98/18541, PCT/US98/19325, PCT/US98/22966, PCT/US98/26925, PCT/US98/27405 and PCT/IB99/00048, all the above cited patent applications and other references cited throughout this specification are incorporated herein by reference in their entireties for all purposes.

### II. Genotyping and Polymorphism Detection Using High Density Probe Arrays

Genotyping involves determining the identity of alleles for a gene, genomic regions or regulatory regions or polymorphic marker possessed by an individual. Genotyping of individuals and populations has many uses. Genetic information about an individual can be used for diagnosing the existence or predisposition to conditions to which genetic factors contribute. Many conditions result not from the influence of a single allele, but involve the contributions of many genes. Therefore, determining the genotype for several genomic regions can be useful for diagnosing complex genetic conditions.

Genotyping of many loci from a single individual also can be used in forensic applications, for example, to identify an individual based on biological samples from the individual. Genotyping of populations is useful in population genetics. For example, the tracking of frequencies of various alleles in a population can provide important information about the history of a population or its genetic transformation over time. For a general review of genotyping and its use. (See Diagnostic Molecular Pathology: A Practical Approach: Cell and Tissue Genotyping (Practical Approach Series) by James O'Donnell McGee (Editor), C. S. Herrington (Editor), ISBN: 0199632383 and SNP and Microsatellite Genotyping : Markers for Genetic Analysis (Biotechniques Molecular Laboratory Methods Series.) by Ali Hajeer (Editor), Jane Worthington (Editor), Sally John (Editor), ISBN 1881299384, both are incorporated herein by reference in their entireties.)

Determining the genotype of a sample of genomic material may be carried out using arrays of oligonucleotide probes. These arrays may generally be “tiled” for a contiguous sequence or a large number of specific polymorphisms. In the case of “tiling” for a contiguous sequence, previously unknown sequence variations can be discovered and characterized.

“Tiling,” as used herein, refers to the synthesis of a defined set of oligonucleotide probes which is made up of a sequence complementary to the target sequence of interest, as well as preselected variations of that sequence, e.g., substitution of one or more given positions with one or more members of the basis set of monomers, i.e., nucleotides. Tiling strategies are discussed in detail in, for example, Published PCT Application No. WO 95/11995, incorporated herein by reference in its entirety for all purposes.

One of skill in the art would appreciate that the methods, software and systems of the invention are not limited to any particular tiling format.

### III. Gene Expression Monitoring

In one aspect of the invention, methods, software and systems are provided to determine the functional significance of a sequence variant (such as a SNP) using gene expression profiling. Gene expression monitoring using GeneChip® high density oligonucleotide probe arrays are described in, for example, Lockhart et al., 1996, Expression Monitoring By Hybridization to High Density Oligonucleotide Arrays, Nature Biotechnology 14:1675-1680; U.S. Pat. Nos. 6,040,138 and 5,800,992, all incorporated herein by reference in their entireties for all purposes.

In the preferred embodiment, oligonucleotide probes are synthesized directly on the surface of the array using photolithography and combinatorial chemistry as disclosed in several patents previous incorporated by reference.

In a preferred embodiment, oligonucleotide probes in the high density array are selected to bind specifically to the nucleic acid target to which they are directed with minimal non-specific binding or cross-hybridization under the particular hybridization conditions utilized. Probes as short as 15, 20, 25 or 30 nucleotides are sufficient to hybridize to a subsequence of a gene and that, for most genes, there is a set of probes that performs well across a wide range of target nucleic acid concentrations. In a preferred embodiment, it is desirable to choose a preferred or “optimum” subset of probes for each gene before synthesizing the high density array.

In some preferred embodiments, the expression of a particular transcript may be detected by a plurality of probes, typically, up to 5, 10, 15, 20, 30 or 40 probes. Each of the probes may target different sub-regions of the transcript. However, probes may overlap over targeted regions.

In some preferred embodiments, each target sub-region is detected using two probes: a perfect match (PM) probe that is designed to be completely complementary to a reference or target sequence. In some other embodiments, a PM probe may be substantially complementary to the reference sequence. A mismatch (MM) probe is a probe that is designed to be complementary to a reference sequence except for some mismatches that may significantly affect the hybridization between the probe and its target sequence. In preferred embodiments, MM probes are designed to be complementary to a reference sequence except for a homomeric base mismatch at the central (e.g., 13th in a 25 base probe) position. Mismatch probes are normally used as controls for cross-hybridization. A probe pair is usually composed of a PM and its corresponding MM probe. The difference between PM and MM provides an intensity difference in a probe pair.

### IV. Systems for Associating Function with Sequence Variations

One of skill in the art would appreciate that many computer systems are suitable for carrying out the methods of the invention. Computer software according to the embodiments of the invention can be executed in a wide variety of computer systems.

For a description of basic computer systems and computer networks. (See Introduction to Computing Systems: From Bits and Gates to C and Beyond by Yale N. Patt, Sanjay J. Patel, 1st edition (Jan. 15, 2000) McGraw Hill Text; ISBN: 0072376902; and Introduction to Client/Server Systems : A Practical Guide for Systems Professionals by Paul E. Renaud, 2nd edition (June 1996), John Wiley & Sons; ISBN: 0471133337, both are incorporated herein by reference in their entireties for all purposes.

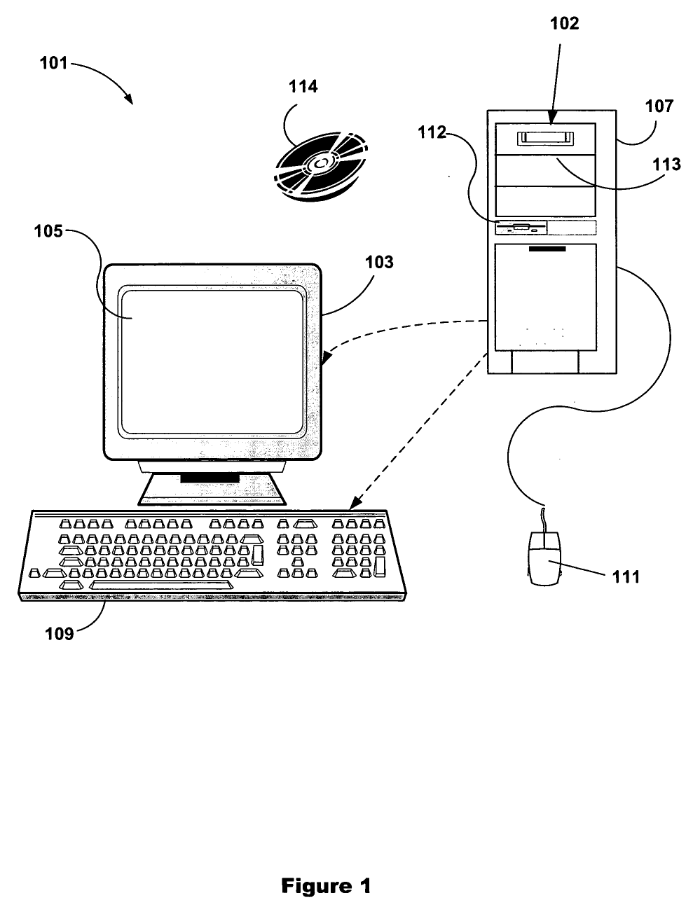

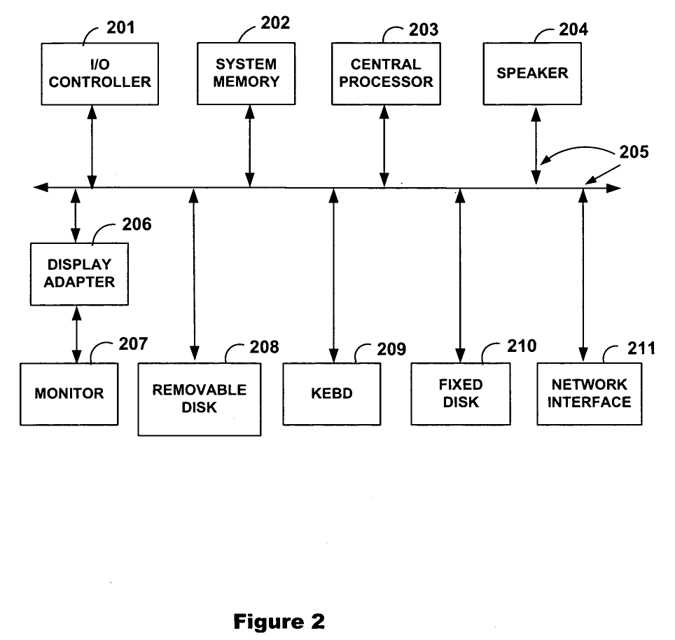

FIG. 1 illustrates an example of a computer system that may be used to execute the software of an embodiment of the invention. FIG. 1 shows a computer system 101 that includes a display 103, screen 105, cabinet 107, keyboard 109, and mouse 111. Mouse 111 may have one or more buttons for interacting with a graphic user interface. Cabinet 107 houses a floppy drive 112, CD-ROM or DVD-ROM drive 102, system memory and a hard drive (113) (see also FIG. 2) which may be utilized to store and retrieve software programs incorporating computer code that implements the invention, data for use with the invention and the like. Although a CD 114 is shown as an exemplary computer readable medium, other computer readable storage media including floppy disk, tape, flash memory, system memory, and hard drive may be utilized. Additionally, a data signal embodied in a carrier wave (e.g., in a network including the Internet) may be the computer readable storage medium.

FIG. 2 shows a system block diagram of computer system 101 used to execute the software of an embodiment of the invention. As in FIG. 1, computer system 101 includes monitor 201, and keyboard 209. Computer system 101 further includes subsystems such as a central processor 203 (such as a Pentium™ III processor from Intel), system memory 202, fixed storage 210 (e.g., hard drive), removable storage 208 (e.g., floppy or CD-ROM), display adapter 206, speakers 204, and network interface 211. Other computer systems suitable for use with the invention may include additional or fewer subsystems. For example, another computer system may include more than one processor 203 or a cache memory. Computer systems suitable for use with the invention may also be embedded in a measurement instrument.

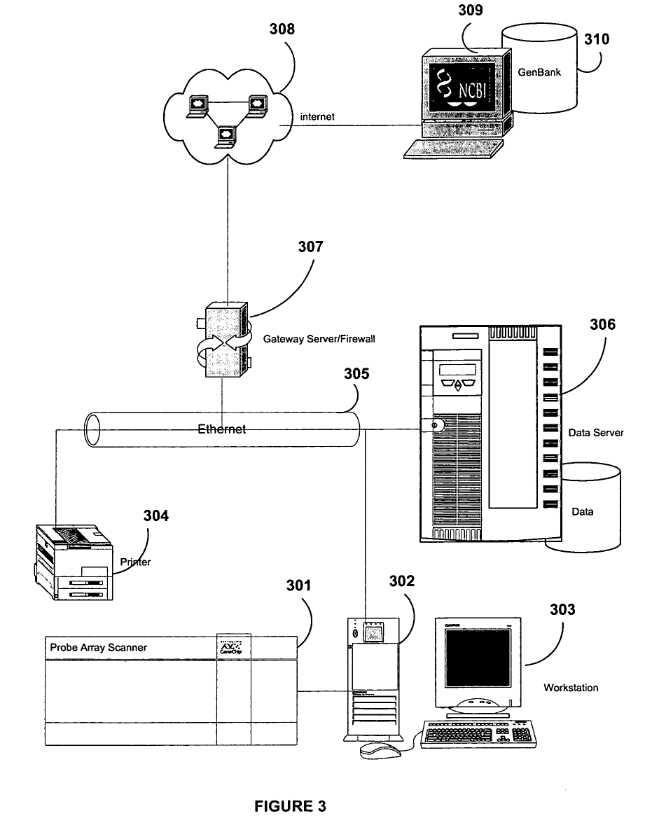

FIG. 3 shows an exemplary computer network that is suitable for executing the computer software of the invention. A computer workstation 302 is connected with and controls a probe array scanner 301. Probe intensities are acquired from the scanner and may be displayed in a monitor 303. The intensities may be processed to make genotype calls (i.e., determining the genotype based upon probe intensities) on the workstation 302. The intensities may be processed and stored in the workstation or in a data server 306. The workstation may be connected with the data server through a local area network (LAN), such as an Ethernet 305. A printer 304 may be connected directly to the workstation or to the Ethernet 305. The LAN may be connected to a wide area network (WAN), such as the Internet 308, via a gateway server 307 which may also serve as a firewall between the WAN 308 and the LAN 305. In preferred embodiments, the workstation may communicate with outside data sources, such as the National Biotechnology Information Center, through the Internet. Various protocols, such as FTP and HTTP, may be used for data communication between the workstation and the outside data sources. Outside genetic data sources, such as the GenBank 310, are well known to those skilled in the art. An overview of GenBank and the National Center for Biotechnology information (NCBI) can be found in the web site of NCBI (http://www.ncbi.nlm.nih.gov).

### V. Associating Phenotype with Genotype

In one aspect of the invention, methods, computer software and systems are provided for associating a phenotype (e.g., expression of a gene) with SNPs identified in individuals with the expression profiles. As used herein, the term “phenotype” refers to the physical, biochemical, and physiological makeup of an individual as determined both genetically and environmentally, as opposed to genotype. Phenotype is more than what is visible by eye or microscope, however, as it includes the full complement of behaviours, the developmental dynamics, as well as the chemical composition of the organism. The term “genotype” refers to genetic constitution of an individual which can be any organism such as a human, a bacteria, a virus, etc. “Polymorphism” refers to the occurrence of two or more genetically determined alternative sequences or alleles in a population. A polymorphic marker or site is the locus at which divergence occurs. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms. “Single Nucleotide Polymorphism” or “SNP” occurs at a polymorphic site occupied by a single nucleotide, which is the site of variation between allelic sequences. This site of variation is usually both preceded by and followed by highly conserved sequences e.g., sequences that vary in less than 1/100 or 1/1000 members of the populations of the given allele. However, rarer SNPs may also be used for the embodiments of the invention. In some instances, rarer SNPs may be associated with or indicative of mutations causing rare diseases. A SNP usually arises due to the substitution of one nucleotide for another at the polymorphic site. These substitutions include both transitions (i.e. the replacement of one purine by another purine or one pyrimidine by another pyrimidine) and transversions (i.e. the replacement of a purine by a pyrimidine or vice versa). SNPs can also arise from either a deletion of a nucleotide or from an insertion of a nucleotide relative to a reference allele.

Haplotype is a set of closely linked genetic markers present on one chromosome which tend to be inherited together (not easily separable by recombination). Some haplotypes may be in linkage disequilibrium.

In one aspect of the invention, methods are provided for identifying single nucleotide polymorphisms (SNPs) whose state, i.e. wild type (WT), heterozygous (Het), or homozygous (Hom), segregate with gene expression data such that a particular SNP state will correlate with change in the level of gene expression. In preferred embodiments, nucleotide variation information derived from hybridization assays in combination with expression information derived from hybridization assays is used to obtain or predict a correlation between a particular genotype and a particular phenotype. In one embodiment, the nucleotide variation information and expression information is obtained by hybridization of nucleic acid samples to high density nucleic acid arrays. Samples form the same individual are hybridized to arrays which are designed to interrogate for nucleotide variation and gene expression information. In some cases, this may involve samples being hybridized to two or more different arrays. In additional embodiments, the sequence variation arrays may be combined with gene expression arrays into one array. For example, probes targeting alternative forms of varying subsequeces may be synthesized or otherwise immobilized on a substrate. These probes can detect the forms as well as quantity of the target sequences. For example, in some embodiments, two probes against a transcript may be used. One of the probe is designed to be perfectly complementary of a target with a wild type SNP state. The other is designed to be perfectly complementary

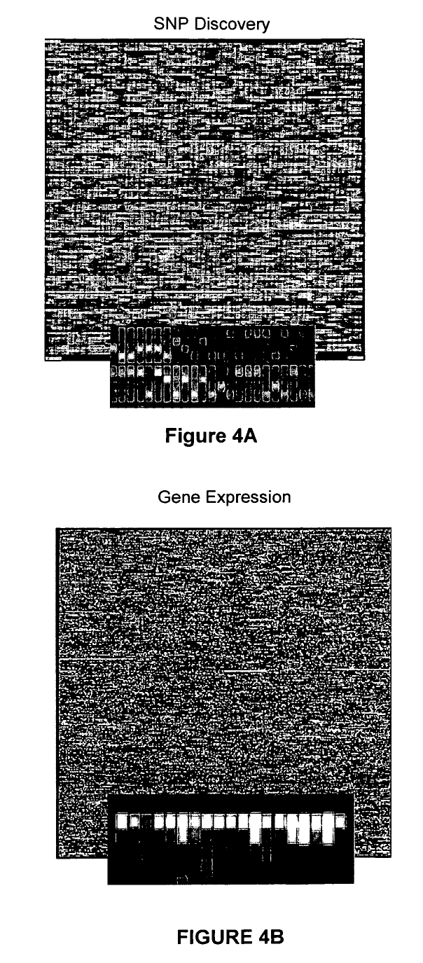

FIG. 4 shows images of nucleic acid sample hybridization with two types of arrays. FIG. 4A shows the hybridization of a nucleic acid sample with a SNP discovery array which detect sequence variations. FIG. 4B shows the hybridization of a nucleic acid sample with a gene expression array which detects the level of the expression of a large number of genes.

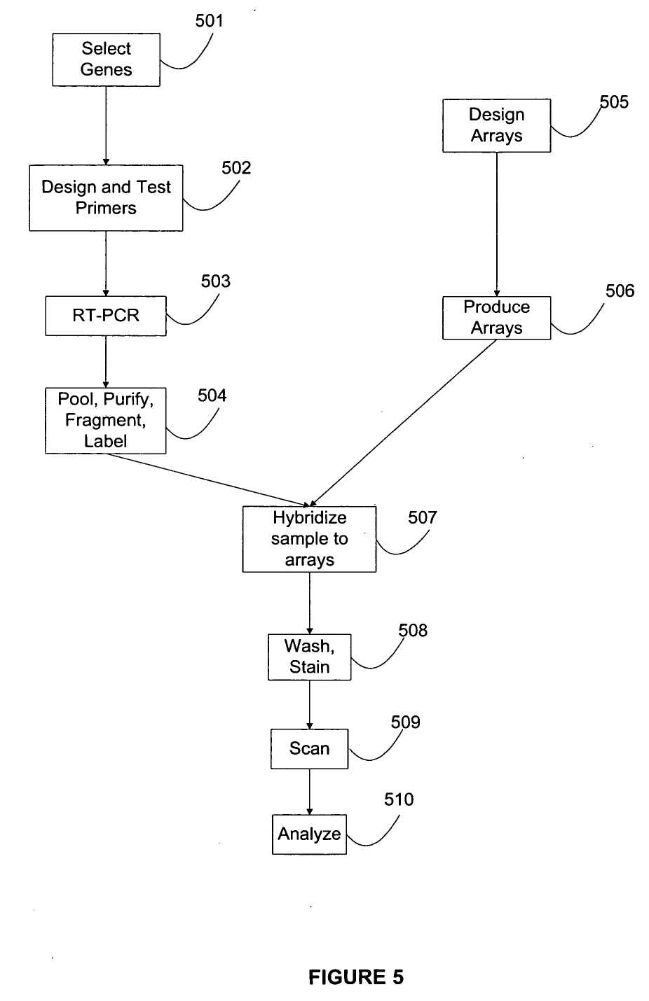

FIG. 5 shows a process of SNP discovery for SNPs that are transcribed. Genes of interest are selected (501). Primers for reverse transcription (RT)-polymerase chain reaction (PCR) are designed and tested (502). Transcripts from a sample is reverse transcribed and then amplifed (503). The term “transcript”, as used herein, include, but are not limited to pre-mRNA transcript(s), transcript processing intermediates, mature mRNA(s) ready for translation and transcripts of the gene or genes, or nucleic acids derived from the mRNA transcript(s). Transcript processing may include splicing, editing and degradation. As used herein, a nucleic acid derived from an mRNA transcript refers to a nucleic acid for whose synthesis the mRNA transcript or a subsequence thereof has ultimately served as a template. Thus, a cDNA reverse transcribed from an mRNA, an RNA transcribed from that cDNA, a DNA amplified from the cDNA, an RNA transcribed from the amplified DNA, etc., are all derived from the mRNA transcript and detection of such derived products is indicative of the presence and/or abundance of the original transcript in a sample. Thus, mRNA derived samples include, but are not limited to, mRNA transcripts of the gene or genes, cDNA reverse transcribed from the mRNA, cRNA transcribed from the cDNA, DNA amplified from the genes, RNA transcribed from amplified DNA, and the like.

The resulting derived nucleic acid sample may be pooled, purified, fragmented and labeled (504) and then hybridized with an array (507). The hybridization is detected and analyzed (508, 509, and 510). The arrays may be gene expression arrays such as the GeneChip(R) HuGeneFL array (Affymetrix, Inc.), genotyping arrays or arrays have the cability of detecting sequence variations as well as quantifying the sequence variations. In some embodiments, the arrays are custom designed based upon the information about the genes, genic regions or other regions of interest (505) and (506). Methods for nucleic acid probe array design, genotyping detection, hybridization, signal detection, and various data analysis methods are described earlier and in, for example, references previously incorporated by reference.

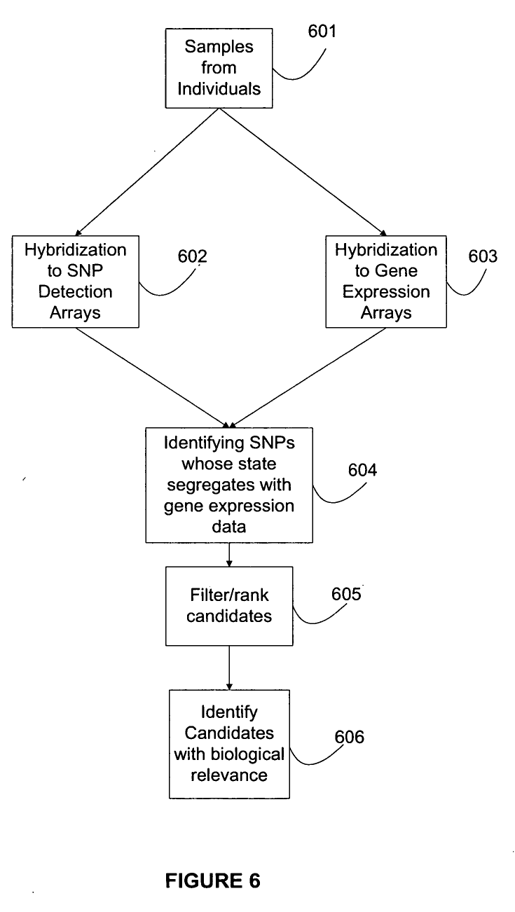

FIG. 6 shows a process for identifying SNPs that may have biological relevance. Biological relevant SNPs, as used herein, may include SNPs that are directly functional (such as those involved in the regulation of gene expression) or SNPs that are indirectly associated with a function. Samples from individuals (601) are used to hybridized to SNP detection arrays (602) and gene expression arrays (603). As discussed earlier, genotyping arrays and gene expression arrays can be combined. The SNP detection arrays may be designed to detect know SNPs or to discover new SNPs. The SNPs whose state segregates with gene expression data are identified (604), and sorted (605). The SNPs whose state highly correlated with the expression of certain genes are identified as having biological relevance (606).

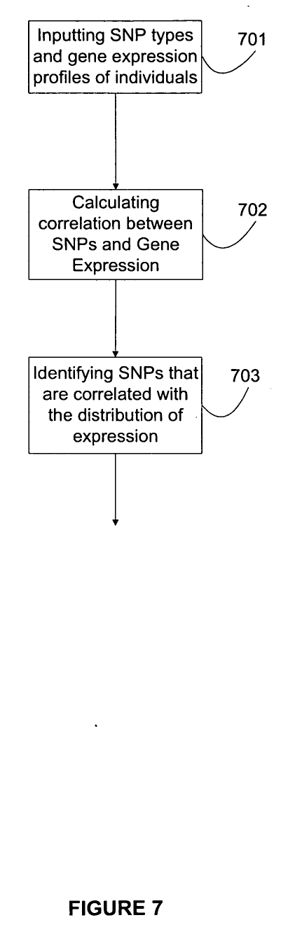

FIG. 7 shows a computerized process for associating genotype (such as the state of a SNP) and phenotype (such as the expression of a particular gene). The SNP states and gene expression profiles of at least 2, preferably at least 10, 20, 50, 100, or 1000 individuals are inputted into a computer system such as the system described above. One of skill in the art would appreciate that data input may be in many suitable ways, such as from a files in a local disk drive, from networked remote computer, from a location in the memory, or from a data stream. The correlation between the state of SNP (genotype) and gene expression is then analyzed. The term correlation, as used herein, refers to the relationship between variables. If the state of the SNP is highly correlated or associated with the expression of one or more genes, the SNP is identified as being putatively related to the expression of the gene(s).

In some embodiments, the correlation or association between state of a SNP and the expression of a gene may be evaluated using the difference in expression of a gene. For example, the expression (in the form of hybridization intensity or fluorescence intensity in the case of using high density oligonucleotide arrays for detection) of a gene in individuals with a wild type SNP may be much larger than the expression of the gene in individuals with a heterzygous/homozygous mutant. In this case, the larger difference in expression indicates that the SNP may be associated with the regulation of the expression of the gene. In contrast, if the expression of a gene is similar in the wild type and the het/hom mutant, the SNP may be not associated with the regulation of the expression of the gene.

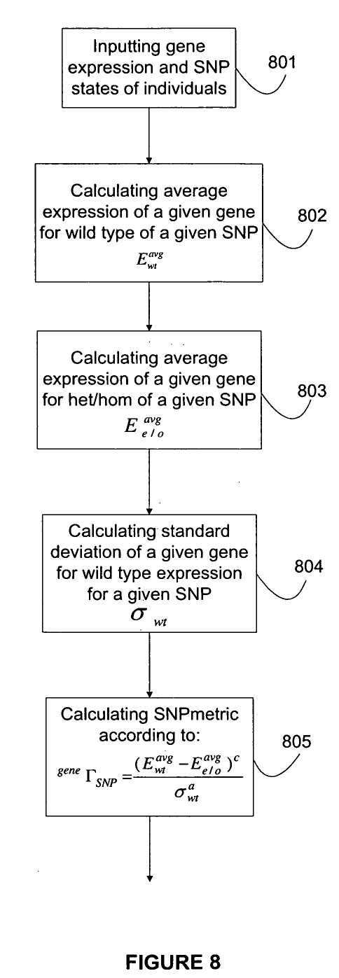

In preferred embodiments, to account for the normal variation in gene expression among individuals with the same genotype, the normalized gene expression difference may be used. FIG. 8 shows a computerized process for calculating a SNPmetric which is used for ranking the genes affected SNPs. In preferred embodiments, gene expressions and SNP states of individuals are inputed (801). A SNPmetric for each SNP and each gene is calculated according to

$${}_{}^{gene}{Γ}{}_{SNP}^{} = \frac{{\vert ( {E}_{wt}^{avg} - {E}_{e / o}^{avg} ) \vert}^{c}}{{σ}_{wt}^{a} {σ}_{e / o}^{b}}$$

$$or$$

$${}_{}^{gene}{Γ}{}_{SNP}^{} = \frac{{\vert ( {E}_{wt}^{avg} - {E}_{e / o}^{avg} ) \vert}^{c}}{{σ}_{wt}^{a} {σ}_{e / o}^{b}}$$

where:
   ^{gene}Γ_{SNP}=SNPmetric for a given gene;
   E_{wt}^{avg}=average gene expression for wild type SNP for the gene;
   E_{e/o}^{avg}=average gene expression for heterozygous/homozygous mutant for the gene;
   σ_{wt}=standard deviation of gene expression of wild type SNP for the gene;
   σ_{e/o}=standard deviation of gene expression of heterozygous/homozygous mutant for the gene; and a, b, c=sensitivity parameters. The sensitivity parameters can be any suitable numeric values. In some instance, a or b can be zero. The sensitivity parameters may be adjusted according to the experiment systems, organisms, etc. In exemplary computer software products of the invention, the software contains code that receive a user's selection or input of the sensitivity parameters. For a given gene, the goal is to maximize gamma to elucidate those SNPs that most closely correlate with the distribution of expression in the test population. The e/o notation is used to indicate separate calculations depending on which genotype is under consideration. In addition, the algorithm to calculate gamma seeks to segregate expression intensities according to their SNP identity. Should a particular SNP be involved in a regulatory region for a particular gene, one could expect that the expression differences between wildtype and heterozygous would be pronounced and that those expression numbers would be peaked around their averages thus producing a smaller standard deviation. Gamma seeks to quantify these properties for easy candidate identification.

Once candidate SNPs are identified, one can then filter and/or rank the candidates and identify those candidates with biological relevance.

In another aspect of the invention, computer software products are provided to perform some steps of the methods of the invention. Computer software products of the invention typically include computer readable medium having computer-executable instructions for performing the logic steps of the methods of the invention. Suitable computer readable medium include floppy disk, CD-ROM/DVD/DVD-ROM, hard-disk drive, flash memory, ROM/RAM, magnetic tapes and etc. The computer executable instructions may be written in any suitable computer language or combination of several languages. Suitable computer languages include C/C++ (such as Visual C/C++), Java, Basic (such as Visual Basic), Fortran, SAS and Perl.

In yet another aspect of the invention, computer systems are provided to perform some steps of the methods. Illustrative architecture of such computer systems have been described earlier. In general, such a computer system contains a processor; and a memory coupled with the least one processor, the memory storing a plurality of machine instructions that cause the processor to perform some steps of the methods of the invention.

The correlation of genotype information with phenotype provides a powerful tool for a wide variety of uses including diagnostics, pharmacogenomics, and research. Once candidate SNPs are identified using the hybridization data and the above disclosed algorithms, it will be possible to correlate variation information from an entire genome with gene expression data from disease relevant tissues. This will allow for the association of variants with function, identification of regulatory regions, and association of variants with disease severity. For example, genetic information can provide a powerful tool for physicians to determine what course of treatment is best for a particular patient. The pharmaceutical industry is likewise interested in the area of pharmacogenomics. Every year pharmaceutical companies suffer large losses from drugs which fail clinical trials for one reason or another. Some of the most difficult are those drugs which, while being highly effective for a large percentage of the population, prove dangerous or even lethal for a very small percentage of the population. Pharmacogenomics can be used to correlate a specific genotype with specific responses to a drug. The basic idea is to get the right drug to the right patient. If pharmaceutical companies (and later, physicians) can accurately remove from the potential recipient pool those patients who would suffer adverse responses to a particular drug, many research efforts which are currently being dropped by pharmaceutical companies could be resurrected saving hundreds of thousands of dollars for the companies and providing many currently unavailable medications to patients.

Similarly, some medications may be highly effective for only a very small percentage of the population while proving only slightly effective or even ineffective to a large percentage of patients. Pharmacogenornics allows pharamaceutical companies to predict which patients would be the ideal candidate for a particular drug, thereby dramatically reducing failure rates and providing greater incentive to companies to continue to conduct research into those drugs.

### CONCLUSION

The present invention provides methods, systems and computer software products for associating phenotypes with genotypes. It is to be understood that the above description is intended to be illustrative and not restrictive. Many variations of the invention will be apparent to those of skill in the art upon reviewing the above description. The scope of the invention should not be limited with reference to the above description, but should instead be determined with reference to the appended claims, along with the full scope of equivalents to which such claims are entitled.

All cited references, including patent and non-patent literature, are incorporated herein by reference in their entireties for all purposes.

1-9. (canceled)

10. A method of correlating gene expression with genotype comprising:
selecting a first plurality of individuals with a first genotype and a second plurality of individuals with a second genotype; wherein the genotypes are the states of a SNP:
obtaining a first plurality of gene expression profiles from the first plurality of individuals;
obtaining a second plurality of gene expression profiles from the second plurality of individuals;
comparing the first and second gene expression profiles; wherein the step of comparing further comprises a step of evaluating the difference in gene expression between the first and second genotypes; and wherein the step of evaluating comprises calculating a normalized difference in gene expression between the first and second genotypes; and
indicating at least one gene whose expression segregates with the genotypes as the genes affected by the genotypes.

11. The method of claim 10 wherein the step of comparing comprises a step of calculating a SNPmetric for each SNP and each gene according to:
$${}_{}^{gene}{Γ}{}_{SNP}^{} = \frac{{( {E}_{wt}^{avg} - {E}_{e / o}^{avg} )}^{c}}{{σ}_{wt}^{a} {σ}_{e / o}^{b}}$$
wherein:
^{gene}Γ_{SNP}=SNPmetric for a given gene;
E_{wt}^{avg}=average gene expression for wild type SNP for the gene;
E_{e/o}^{avg}=average gene expression for heterozygous/homozygous mutant for the gene;
σ_{wt}=standard deviation of gene expression of wild type SNP for the gene.
σ_{e/o}=standard deviation of gene expression of heterozygous/homozygous mutant for the gene; and
a, b, c=sensitivity parameters.

12. The method of claim 10 wherein the step of comparing comprises a step of calculating a SNPmetric for each SNP and each gene according to:
$${}_{}^{gene}{Γ}{}_{SNP}^{} = \frac{{\vert ( {E}_{wt}^{avg} - {E}_{e / o}^{avg} ) \vert}^{c}}{{σ}_{wt}^{a} {σ}_{e / o}^{b}}$$
wherein:
^{gene}Γ_{SNP}=SNPmetric for a given gene;
E_{wt}^{avg}=average gene expression for wild type SNP for the gene;
E_{e/o}^{avg}=average gene expression for hetrozygous/homozygous mutant for the gene;
σ_{wt}=standard deviation of gene expression of wild type SNP for the gene;
σ_{e/o}=standard deviation of gene expression of heterozygous/homozygous mutant for the gene; and
a, b, c=sensitivity parameters.

13-33. (canceled)

34. A computer readable medium comprising computer-executable instructions for performing the method for correlating gene expression with genotypes comprising:
inputing a first plurality of gene expression profiles from a plurality of individuals with a first genotype; wherein the genotypes are the states of a SNP; and
inputing a second plurality of gene expression profiles from a plurality of individuals with a second genotype;
comparing the first and second gene expression profiles; and wherein said comparing step further comprises the step of evaluating the difference in gene expression between the first and second genotypes; and wherein the step of evaluating comprises calculating a normalized difference in gene expression between the first and second genotypes; and
indicating at least one gene whose expression segregates with the genotypes as the genes affected by the genotypes.

35. The computer readable medium of claim 34 wherein the step of comparing comprises a step of calculating a SNPmetric for each SNP and each gene according to:
$${}_{}^{gene}{Γ}{}_{SNP}^{} = \frac{{( {E}_{wt}^{avg} - {E}_{e / o}^{avg} )}^{c}}{{σ}_{wt}^{a} {σ}_{e / o}^{b}}$$
wherein:
^{gene}Γ_{SNP}=SNPmetric for a given gene;
E_{wt}^{avg}=average gene expression for wild type SNP for the gene;
E_{e/o}^{avg}=average gene expression for heterozygous/homozygous mutant for the gene;
σ_{wt}=standard deviation of gene expression of wild type SNP for the gene;
σ_{e/o}=standard deviation of gene expression of heterozygous/homozygous mutant for the gene; and
a, b, c=sensitivity parameters.

36. The computer readable medium of claim 34 wherein the step of comparing comprises a step of calculating a SNPmetric for each SNP and each gene according to:
$${}_{}^{gene}{Γ}{}_{SNP}^{} = \frac{{\vert ( {E}_{wt}^{avg} - {E}_{e / o}^{avg} ) \vert}^{c}}{{σ}_{wt}^{a} {σ}_{e / o}^{b}}$$
wherein:
^{gene}σ_{SNP}=SNPmetric for a given gene;
E_{wt}^{avg}=average gene expression for wild type SNP for the gene;
E_{e/o}^{avg}=average gene expression for heterozygous/homozygous mutant for the gene;
σ_{wt}=standard deviation of gene expression of wild type SNP for the gene;
σ_{e/o}=standard deviation of gene expression of heterozygous/homozygous mutant for the gene; and
a, b, c=sensitivity parameters.

37-45. (canceled)

46. A system for associating a genotype with gene expression comprising:
a processor; and
a memory coupled with the least one processor, the memory storing a plurality of machine instructions that cause the processor to perform logical steps, wherein the logical steps include:
obtaining a first plurality of gene expression profiles from a plurality of individuals with a first genotype;
obtaining a second plurality of gene expression profiles from a plurality of individuals with a second genotype; wherein the genotypes are the states of a SNP;
comparing the first and second gene expression profiles; wherein said comparing step further comprises a step of evaluating the difference in gene expression between the first and second genotypes; and wherein the step of evaluating comprises calculating a normalized difference in gene expression between the first and second genotypes; and
indicating at least one gene whose expression segregates with the genotypes as the genes affected by the genotypes.

47. The system of claim 46 wherein the step of comparing comprises a step of calculating a SNPmetric for each SNP and each gene according to:
$${}_{}^{gene}{Γ}{}_{SNP}^{} = \frac{{( {E}_{wt}^{avg} - {E}_{e / o}^{avg} )}^{c}}{{σ}_{wt}^{a} {σ}_{e / o}^{b}}$$
wherein:
^{gene}Γ_{SNP}=SNPmetric for a given gene;
E_{wt}^{avg}=average gene expression for wild type SNP for the gene;
E_{e/o}^{avg}=average gene expression for heterozygous/homozygous mutant for the gene;
σ_{wt}=standard deviation of gene expression of wild type SNP for the gene;
σ_{e/o}=standard deviation of gene expression of heterozygous/homozygous mutant for the gene; and
a, b, c=sensitivity parameters.

48. The system of claim 46 wherein the step of comparing comprises a step of calculating a SNPmetric for each SNP and each gene according to:
$${}_{}^{gene}{Γ}{}_{SNP}^{} = \frac{{\vert ( {E}_{wt}^{avg} - {E}_{e / o}^{avg} ) \vert}^{c}}{{σ}_{wt}^{a} {σ}_{e / o}^{b}}$$
wherein:
^{gene}Γ_{SNP}=SNPmetric for a given gene;
E_{wt}^{avg}=average gene expression for wild type SNP for the gene;
E_{e/o}^{avg}=average gene expression for heterozygous/homozygous mutant for the gene;
σ_{wt}=standard deviation of gene expression of wild type SNP for the gene;
σ_{e/o}=standard deviation of gene expression of heterozygous/homozygous mutant for the gene; and
a, b, c=sensitivity parameters.
